(19) United States
(12) Patent Application Publication
(10) Pub. No.: US 2023/0382085 A1
(43) Pub. Date: Nov. 30, 2023

(54) Seals for Optical Components

(71) Applicant: Apple Inc., Cupertino, CA (US)

(72) Inventors: Zachary M Beiley, Oakland, CA (US); Brent J Bollman, Alameda, CA (US); Derrick T Carpenter, Superior, CO (US); Benjamin P Cherniawski, Amherst, MA (US); Boyi Fu, San Jose, CA (US); Nathan K Gupta, Hillsborough, CA (US); Wei Lin, Santa Clara, CA (US); Graham C Nelson, San Diego, CA (US); Isik I Nugay Ozel, San Diego, CA (US); Zhipeng Pan, Milpitas, CA (US); Alexander D Schlaupitz, Longmont, CO (US); Kristina M Serratto, Burlingame, CA (US); Ying-Da Wang, Taipei (TW); Da Yu, San Jose, CA (US); Tyler A Marshall, Fremont, CA (US)

(21) Appl. No.: 18/447,209

(22) Filed: Aug. 9, 2023

Related U.S. Application Data
(63) Continuation-in-part of application No. PCT/US2022/042305, filed on Sep. 1, 2022.
(60) Provisional application No. 63/303,864, filed on Jan. 27, 2022.
(60) Provisional application No. 63/244,181, filed on Sep. 14, 2021.

(51) Int. Cl. B32B 17/10

(52) U.S. Cl. CPC B32B 17/10302; B32B 2307/51; B32B 2315/02; B32B 2383/00; B32B 2333/08

(57) ABSTRACT

An electronic device may have optical components that each have first and second transparent layers such as first and second glass layers. The glass layers may have outer surfaces that face away from each other and inner surfaces that face towards each other. A polymer layer is formed between the inner surfaces of the glass layers. Along the periphery of each optical component, a hermetic seal is formed to protect the polymer material of the polymer layer. The seal may have a moisture barrier layer that is attached to the first and second glass layers. The moisture barrier layer may be supported by an elastomeric buffer member. The moisture barrier layer may be formed from metal film or a polymer layer or other substrate that is coated with a moisture-impermeable coating. The moisture-impermeable coating may be formed from one or more thin-film metal layers and/or one more thin-film dielectric layers.

This application is a continuation-in-part of co-pending International Application No. PCT/US2022/042305, filed Sep. 1, 2022, which claims priority to U.S. provisional patent application No. 63/303,864, filed Jan. 27, 2022, and U.S. provisional patent application No. 63/244,181, filed Sep. 14, 2021. The above applications are hereby incorporated by reference herein in their entireties.

### FIELD

This relates generally to electronic devices, and, more particularly, electronic devices with optical components.

### BACKGROUND

Electronic devices may have optical components. For example, electronic devices may have waveguides and other structures that are formed from transparent materials. These materials may be susceptible to chemical or moisture-induced degradation if exposed to excess moisture. Additionally, these materials may contain volatile species which induce degradation if they leave the system.

### SUMMARY

An electronic device may have a support structure that supports one or more optical components. Each optical component may have first and second transparent layers such as first and second glass layers. The glass layers may have outer surfaces that face away from each other and inner surfaces that face towards each other. A moisture-sensitive polymer layer (e.g., an organic polymer layer) may be formed between the inner surfaces of the glass layers.

Along the periphery of each optical component, a moisture barrier may be formed to protect the polymer material of the polymer layer. The moisture barrier may provide a hermetic seal that extends between the first and second glass layers. The seal may include a moisture barrier layer such as a layer of metal foil or a polymer layer coated with a moisture barrier coating such as a metal or inorganic dielectric thin-film coating.

### BRIEF DESCRIPTION OF THE DRAWINGS

FIG. 1 is a cross-sectional side view of an illustrative electronic device in accordance with an embodiment.

FIG. 2 is a front view of an illustrative optical component with a peripheral seal in accordance with an embodiment.

FIG. 3 is a cross-sectional view of an illustrative peripheral seal for an optical component in accordance with an embodiment.

FIGS. 4A, 4B, 5, 6, 7, and 8 are views of additional illustrative peripheral seals for an optical component in accordance with embodiments.

FIG. 9 is a cross-sectional side view of an illustrative peripheral seal with a polymer substrate layer having a moisture barrier coating in accordance with an embodiment.

FIG. 10 is a cross-sectional side view of an illustrative peripheral seal with a solder-sealed seam in accordance with an embodiment.

FIG. 11 is a cross-sectional side view of an illustrative peripheral seal with a mesh-tape-sealed seam in accordance with an embodiment.

FIG. 12 is a diagram of an illustrative mesh tape in accordance with an embodiment.

FIG. 13 is a cross-sectional side view of illustrative mesh tape in accordance with an embodiment.

FIGS. 14 and 15 are cross-sectional side views of illustrative peripheral seals with electroplated moisture barrier coating layers in accordance with an embodiment.

FIGS. 16 and 17 are cross-sectional side views of illustrative peripheral seals with multilayer coatings in accordance with an embodiment.

FIG. 18 is a cross-sectional view of an illustrative peripheral seal having hermetic and non-hermetic bonds for an optical component in accordance with an embodiment.

FIG. 19 is a partial front view of a peripheral seal having hermetic and non-hermetic bonds in accordance with an embodiment.

FIGS. 20 and 21 are views of additional illustrative peripheral seals having hermetic and non-hermetic bonds for an optical component in accordance with some embodiments.

### DETAILED DESCRIPTION

An electronic device may have housing structures. The housing structures, which may sometimes be referred to as support structures, may be used to support and/or enclose device components such as batteries, displays, integrated circuits, sensors, other circuitry, and optical components. Examples of optical components that may be used in the electronic device include lenses and lenses with embedded waveguides, optical devices with sensitive coatings, displays such as liquid crystal displays (e.g., displays in which arrays of liquid crystal pixels are sandwiched between inner and outer glass layers and polarizers), organic light-emitting diode displays (e.g., displays with organic light-emitting diode pixels sandwiched between glass layers or other layers), and/or other optical elements. The housing structures of the device may be configured to be mounted on a stand or in a frame, may be configured to rest on a desktop or other surface, or may be configured to be worn on a body part of a user (e.g., a wrist, arm, head, or other body part). During operation, an electronic device may use sensors and other circuitry to gather user input and other data and may use displays and other output devices to provide output for a user.

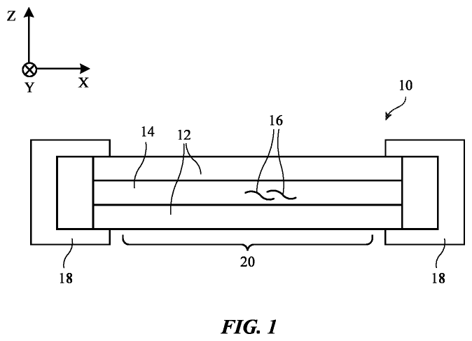

A cross-sectional view of a portion of an illustrative electronic device is shown in FIG. 1. As shown in FIG. 1, electronic device 10 may have one or more optical components (sometimes referred to as optical elements) such as optical component 20. Each optical component 20 may be supported by housing 18. Housing 18 may be a wearable housing or other suitable housing. Housing 18 may be formed from polymer, metal, and/or other suitable materials. Housing 18 may have one or more portions that are attached to optical component 20 to support optical component 20 during use of device 10 by a user.

In the example of FIG. 1, optical component 20 has a layer of polymer (e.g., a polyurethane-based polymer or other polymer) such as polymer layer 14. Layer 14 may be sandwiched between a first transparent substrate (layer) 12 and an opposing second transparent substrate (layer) 12. Substrates 12 may be transparent layers that each have an outwardly facing surface and an inwardly facing surface. The outwardly facing surfaces of substrates 12 may face away from each other. The inwardly facing surfaces of substrates 12 may face each other. In some embodiments, pixels or other structures may be sandwiched between substrates 12. Illustrative configurations in which a polymer layer such as layer 14 is sandwiched between substrates 12 are sometimes described as an example.

Substrates 12 may be formed from glass (e.g., strengthened glass, ceramic glass, high index of refraction glass, and/or other layers of glass), transparent crystalline material such as sapphire, transparent ceramic, transparent polymer, and/or other transparent substrate material. In an illustrative configuration, which may sometimes be described herein as an example, substrates 12 are glass substrates (sometimes referred to as glass layers or glass members). The inner and outer surfaces of each substrate 12 may have planar areas (e.g., areas that lie in the X-Y plane of FIG. 1) and/or may have areas characterized by curved cross-sectional profiles (e.g., convex and/or concave areas). In an illustrative configuration, the outwardly facing surface of one of substrates 12 may be fully or partly convex whereas the outwardly facing surface of the other of substrates 12 may be fully or partly concave. Substrates 12 may be coated with one or more layers of optical coatings to alter their reflectance spectra, absorption spectra, and/or transmission spectra.

Optical component 20 may serve as a lens that passes light (e.g., light traveling along the Z axis of FIG. 1). The lens may form a waveguide that transports image light from a display (e.g., image light may be transported within the waveguide along a direction lying in the X-Y plane in the example of FIG. 1). During fabrication of optical component 20, polymer layer 14 may be processed to form a structure for a display or other optical structure such as optical structure 16.

Polymer layer 14 may be sensitive to water. To prevent degradation of polymer layer 14 and structure 16 due to exposure to moisture in the environment, layer 14 may be hermetically sealed. In particular, the periphery of optical component 20 may be provided with a hermetic seal. The hermetic seal may prevent ingress of environmental contamination into layer 14 and may prevent egress of volatile compounds and/or moisture from layer 14 to the exterior region surrounding component 20, thereby helping to prevent degradation to layer 14.

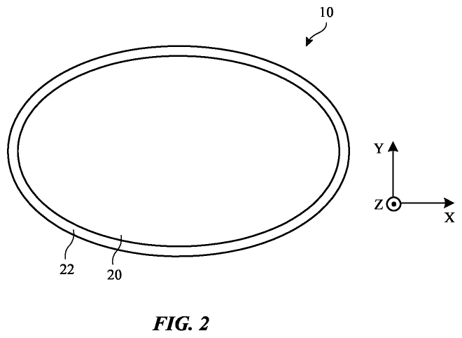

FIG. 2 is a front view of an illustrative optical component 20 showing how seal 22 may run along the periphery of element 20, thereby preventing moisture ingress at any location on the edge of element 20. Element 20 of FIG. 2 has an oval footprint, but may, in general, have any suitable shape (e.g., a rectangular outline, a circular outline, a teardrop outline, an outline with a combination of straight and curved peripheral edges, and/or other suitable shape). Seal 22, which may sometimes be referred to as a moisture barrier seal or moisture seal, may be formed from one or more barrier layers that are impervious to moisture and/or other structures that provide structural support, adhesion, seam sealing, etc.

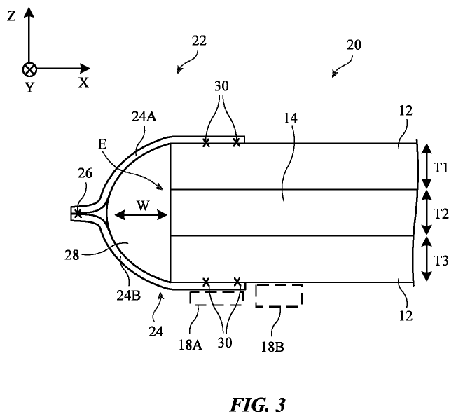

Consider, as an example, the cross-sectional side view of optical component 20 of FIG. 3. As shown in FIG. 3, optical component 20 may have first and second substrates 12. Polymer layer 14 may be formed between substrates 12. When left unprotected, moisture can enter polymer layer 14 at peripheral edge E of component 20. To hermetically seal component 20 and thereby protect layer 14 from moisture ingress, seal 22 may be formed along edge E and may run around the entire periphery of component 20 as shown in FIG. 2.

In the example of FIG. 3, seal 22 includes an elastomeric buffer member such as buffer 28 that supports moisture barrier layer 24 (sometimes referred to as a hermetic barrier layer, environmental barrier layer, or barrier layer). Barrier layer 24 in the example of FIG. 3 includes a first portion formed from barrier layer 24A and a second portion formed from barrier layer 24B. Layers 24A and 24B are joined at bond 26 (e.g., using solder, laser welds or other welds, adhesive, and/or other bond mechanisms that bond the mated surfaces of layers 24A and 24B together). By attaching layers 24A and 24B together in this way, layers 24A and 24B form a unified moisture barrier layer for seam 22 (layer 24).

To seal edge E, layer 24 is bonded over edge E by attaching a first edge of layer 24 to a first of substrates 12, as shown by bond 30 between layer 24A and the outer surface of the first substrate 12, and by attaching an opposing second edge of layer 24 to a second of substrates 12, as shown by bond 30 between layer 24B and the outer surface of the second substrate 12. Bonds 30 may be formed by adhesive, solder, or other material for forming hermetically sealed joints between layer 24 and the glass or other material of substrates 12. For example, bonds 30 may be formed using adhesives exhibiting low water vapor transmission rates such as polyisobutylene, epoxy, acrylic core tape, silver-based glue, fluorosilicones, or other adhesives, may be formed from metal solder based on indium-tin alloys or other metals, and/or may be formed by direct bonding in which the metal foil or other material of layer 24 is directly welded to the glass or other material of substrates 12. If desired, layer 24 may be formed from solder foil, allowing solder bonds to be formed directly between foil surfaces (e.g., for soldered foil-foil joints and soldered foil-glass bonds). In some configurations, metal layers (e.g., strips of metal running along the periphery of component 20) are formed on the surfaces of substrates 12 to help allow solder bonds to be formed (e.g., to enhanced solder adhesion to substrates 12).

The thicknesses T1 and T3 of substrates 12 may be equal or the values of T1 and T2 may be different from each other. Thicknesses T1 and T3 may have values of 50 microns to 1000 microns or 100 microns to 400 microns or other suitable substrate thicknesses may be used in forming substrates 12 for element 20 (e.g., T1 and/or T3 may be at least 50 microns, at least 200 microns, at least 250 microns, less than 1000 microns, less than 700 microns, less than 350 microns, etc.). The thickness T2 of polymer layer 14 may be 400 microns to 800 microns, at least 200 microns, at least 300 microns, at least 450 microns, less than 1200 microns, less than 750 microns, less than 600 microns, etc.

Layer 24 may be formed from a material such as metal foil (e.g., foil formed from aluminum, stainless steel, copper, nickel, and/or other metals), low water vapor transmission rate plastics such as polychlorotrifluoroethylene (PCTFE), or higher water vapor transmission rate plastics which are coated in a barrier film to reduce their water transmission, or other material(s) impermeable to moisture. The thickness of layer 24 may be 5-45 microns, at least 5 microns, at least 10 microns, at least 15 microns, at least 20 microns, at least 40 microns, less than 100 microns, less than 75 microns, less than 60 microns, less than 30 microns, or other suitable thickness. Layer 24 is preferably sufficiently thin to be bent into a desired shape for seal 22 while being sufficiently thick to exhibit desired strength while serving as a moisture barrier. Thinner foils tend to offer less resistance to thermal movement. Thicker foils tend to offer better handling and moisture barrier properties. Layer 24 preferably has a thickness and composition that allows layer 24 to be formed into a desired shape (e.g., under heat and/or pressure). As an example, layer 24 may have a thickness of less than 100 microns or less than 50 microns so that a desired three-dimensional shape may be embossed and/or otherwise molded (pressed) into layer 24.

Buffer 28, which may sometimes be referred to as a buffer member, support member, moisture barrier layer support, or support structure, may be formed from an elastomeric material or other compliant material. This allows buffer 28 to expand and contract to accommodate temperature-induced changes in the thickness of element 20 (e.g., the compliant nature of buffer 28 helps avoid stress due to possible mismatch between the coefficient of thermal expansion of each of the layers of element 20 and the coefficient of thermal expansion of buffer 28).

Examples of suitable materials for buffer 28 include silicone, polyisobutylene, polyvinylidene difluoride, neoprene, and nitril rubber. These materials may exhibit desirable properties such as an ability to match temperature-induced expansion in layer 14 (e.g., if the coefficient of thermal expansion of layer 14 is greater than 200 ppm/C, buffer 28 may exhibit an approximately matched coefficient of thermal expansion of 100-300 ppm/C), a low modulus of elasticity (e.g., less than 10 MPa), chemical compatibility with layer 14, low solubility to liquid components in layer 14, a low water vapor transmission rate, satisfactory adhesion to the edge of component 20, minimal permanent deformation under applied stress (e.g., over a temperature range of −40 to 85 C or other suitable temperature range), a glass transition temperature outside of the expected operating range of device 10 (e.g., a glass transition temperature of less than −40 C or >85 C in one illustrative configuration), and a black appearance or other optically opaque appearance (e.g., less than 0.5% reflectivity) to help suppress stray light. Buffer 28 may have a C-shaped profile as shown in the example of FIG. 3 or any other suitable cross-sectional shape.

Layers 24A and 24B of seal 22 may have the same shape and size (e.g., so that layer 24 is symmetrical about bond 26) or layers 24A and 24B may have different shapes and/or sizes (e.g., so that the shape of layer 24 is asymmetrical). The portions of layers 24A and 24B that are joined at bond 26 may be bent upwards or downwards to help reduce the lateral size of seal 22.

The lateral dimension (width W) of buffer 28 may be at least 400 microns, at least 800 microns, at least 1600 microns, less than 4000 microns, less than 2000 microns, less than 1100 microns, less than 550 microns, less than 350 microns, or other suitable width. The support that buffer 28 provides to layer 24 may help prevent damage to layer 24 during assembly and use of device 10. If desired, buffer 28 may be omitted (e.g., so that an air gap is present between the inner surface of layer 24 and edge E of element 20). This can ease assembly of the structure.

The portion of housing 18 that supports element 20 may be mounted over an edge portion of layer 24 (see, e.g., housing 18A of FIG. 3) and/or may support element 20 at a portion of element 20 that is not overlapped by layer 24 (see, e.g., housing 18B of FIG. 3).

Using a hermetic sealing arrangement of the type shown in FIG. 3 or other hermetic sealing arrangement, layer 14 may be hermetically sealed (e.g., the entrance of moisture including moist substances such as sunscreen and perspiration, and/or other environmental contaminants into layer 14 from the exterior region surrounding layer 14 may be blocked and/or the egress of mobile compounds—e.g., moisture and/or small molecules and/or other mobile species—from within layer 14 to the exterior region surrounding layer 14 may be blocked). This helps preserve the integrity of layer 14 and prevents the performance of layer 14 from degrading. For example, the hermetic sealing of layer 14 may help preserve structures in layer 14.

Optical performance can also be preserved by configuring the hermetic seal to preserve the shape of element 20 over a range of operating temperatures (e.g., by ensuring that the edge does not become overly compressed or expanded relative to the center of element 20 during temperature fluctuations. Consider, as an example, a scenario in which element 20 has planar layers 12 and 14 or other layers 12 and 14 that are characterized by a center thickness (e.g., a first thickness CT1 that is measured in center of element 20) and an edge thickness (e.g., a second thickness CT2 that is measured adjacent to the periphery of element 20). Optical performance can be maintained for element 20 by configuring the hermetic seal of element 20 so that the change in CT1 over a given temperature range does not differ too much from the change in CT2 over the same given temperature range.

With an illustrative configuration, buffer 28 is formed from a low modulus (less than 10 MPa, as an example) elastomeric polymer such as silicone that exhibits a coefficient of thermal expansion of 100-300 ppm/° C., layers 12 are glass layers, and layer 14 is a polymer with thickness of about 600 microns and a lateral dimension of about 4-6 cm, and layer 24 is a one-part or multi-part barrier film having a metal layer (e.g., 10 microns of aluminum) on a polymer substrate (e.g., a 40 micron thick polypropylene film). With this illustrative configuration, seal 22 helps ensure that the change in CT1 differs from the change in CT2 by less than 0.5% and preferably by less than 0.1% over a temperature range of 0-45° C.

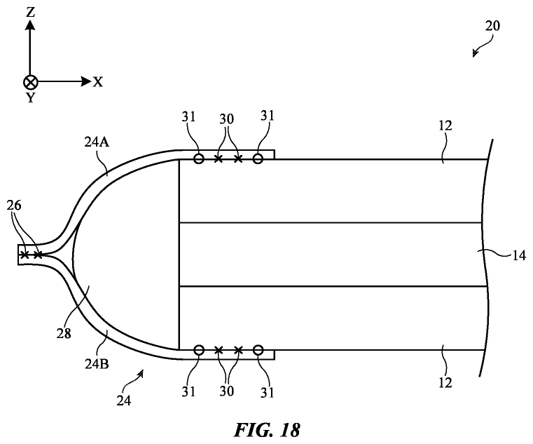

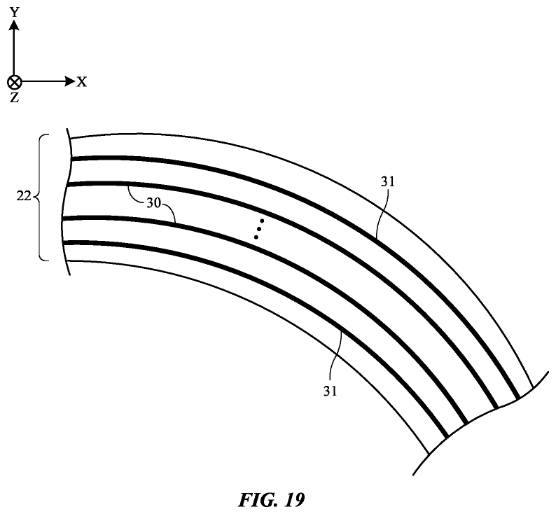

Bonds 30 of FIG. 3 that are used to form hermetically sealed joints between layer 24 and the glass or other material of substrate 12 are illustrative. FIG. 18 shows another embodiment in which different types of bonds are used to attach layer 24 to substrate 12. As shown in FIG. 18, bonds 30 may represent a first type of connection and bonds 31 may represent a second type of connection for attaching layer 24 to substrate 12. Bonds 30 may represent hermetically sealed joints between layer 24 and substrate 12, whereas bonds 31 may represent non-hermetically sealed joints between layer 24 and substrate 12. As such, bonds 30 can be referred to and defined herein as moisture-sealing, moisture-impervious, or hermetic joints, whereas bonds 31 can be referred to and defined herein as non-moisture-sealing, non-moisture-impervious, or non-hermetic joints.

The hermetic bonds 30 may provide a first amount of mechanical bonding strength, whereas the non-hermetic bonds 31 may provide a second level of mechanical bonding strength greater than the first level of mechanical bonding strength (e.g., hermetic bonds 30 provide weaker mechanical support than non-hermetic bonds 31). The non-hermetic bonds 31 can therefore provide improved structural support for ensuring that the connection between layers 12 and 24 is mechanically sound. The hermetic bonds 30 are therefore sometimes referred to and defined herein as structural or load-bearing joints, whereas the non-hermetic bonds 31 are sometimes referred to and defined herein as non-structural or non-load-bearing joints. The use of load-bearing bonds 31 in addition to the non-load-bearing but hermetic bonds 30 can help relieve mechanical stress that might otherwise be applied to the hermetic bonds 30, which can be beneficial and technically advantageous to prevent cracks, damage to substrate 12, or other mechanical failure in seal 22 of optical component 20.

In the example of FIG. 18, the non-hermetic bonds 31 are formed on both sides of the hermetic bonds 30. As another example, the non-hermetic bonds 31 can optionally be formed on only one side of the hermetic bonds 30 (e.g., the non-hermetic bonds can be formed along an inner peripheral edge of bonds 30 or can be formed along an outer peripheral edge of bonds 30). If desired, the non-hermetic bonds 31 can also be formed between adjacent hermetic bonds 30 (e.g., load-bearing bonds 31 can be disposed between non-load-bearing bonds 30). In other embodiments, bonds 26 in the tail portion where layers 24A and 24B are joined can also be mechanically reinforced by non-hermetic bonds 31.

In general, load-bearing bonds 31 may be formed by adhesive, solder, or other material for forming non-hermetically sealed joints between layer 24 and the glass or other material of substrates 12. For example, bonds 31 may be formed using adhesives exhibiting low water vapor transmission rates such as polyisobutylene, epoxy, acrylic core tape, silver-based glue, fluorosilicones, or other adhesives, may be formed from metal solder based on indium-tin alloys or other metals, and/or may be formed by direct bonding in which the metal foil or other material of layer 24 is directly welded to the glass or other material of substrates 12. Bonds 31 may be continuous or discrete laser welds. Bonds 30 may be formed using a first laser welding process, whereas bonds 31 may be formed using a second laser welding process separate from the first laser welding process.

FIG. 19 is a partial front view of a peripheral seal 22 having hermetic and non-hermetic bonds. As shown in FIG. 19, peripheral seal 22 includes at least two continuous strips or rings of hermetic bonds 30. This is exemplary. As another example, peripheral seal 22 might include only one strip of hermetic bonding 30. As another example, peripheral seal 22 might include more than two strips (rings) of hermetic bonding 30. In the example of FIG. 19, a first strip of non-hermetic (load-bearing) bonding 31 may be disposed along the outer peripheral edge of the hermetic bonding 30, and a second strip of non-hermetic (load-bearing) bonding 31 can be disposed along the inner peripheral edge of the hermetic bonding 30. Although the non-hermetic bonding 31 is illustrated as one or more continuous joints, the non-hermetic bonding 31 can optionally be implemented as a linear array of discrete (non-continuous) joints forming a non-continuous structure along one or more edges of the hermetic bonding 30. Since bonds 31 are configured to provide mechanical (load-bearing) support rather than hermetic sealing, bonds 31 need not form a continuous strip or joint. As another example, one or more continuous strips or arrays of discrete non-hermetic bonds 31 can be disposed between adjacent hermetic bonding rings 30. As another example, one or more continuous strips or arrays of discrete non-hermetic bonds 31 can be disposed on only one side (e.g., along the outer or inner peripheral edge) of the hermetic bonding rings 30.

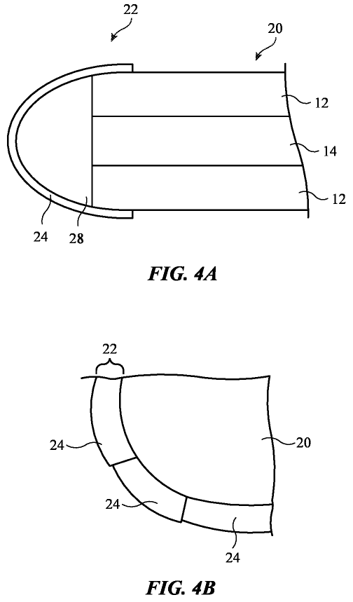

The configurations for seal 22 that are shown in FIGS. 3 and 18 are illustrative. Other configurations may be used, if desired (e.g., other configurations that exhibit less than 0.5% or less than 0.1% in thickness change between CT1 and CT2 as temperature varies from 0 to 45° C.). As shown in FIG. 4A, layer 24 may be formed from a single layer that runs from a first of substrates 12 to a second of substrates 12. This type of arrangement may allow layer 24 to take on a C-shaped profile as shown in FIG. 4A. To help reduce buckling of the metal foil or other material being used to form layer 24 as seam 22 curves around curved portions of the periphery of element 20 and to facilitate attachment of layer 24 around the entire periphery of element 20, layer 24 of FIG. 4A may be formed from multiple disjoint segments located at different respective locations along the periphery of element 20. The ends of these segments may overlap each other and be bonded to each other to help ensure hermetic sealing, as shown by the overlapping foil segments making up layer 24 for peripheral seal 22 in FIG. 4B, which is a front view of an illustrative portion of component 22 and seal 22.

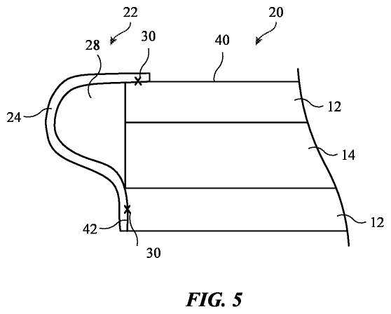

As shown in FIG. 5, buffer 28 may have a non-C-shaped profile such as a P-shaped profile. FIG. 5 also illustrates how layer 24 need not only be bonded to the outer surfaces of substrates 12. In the FIG. 5 example, a first edge of layer 24 is attached with a first bond 30 to outer surface 40 of a first of substrates 12 and an opposing second edge of layer 24 is attached with a second bond 30 to peripheral edge surface 42 of a second of substrates 12. In general, layer 24 (whether formed from a single piece that spans the first and second substrates or whether formed from first and second pieces that are joined using bond 26 as shown in FIG. 3) may be attached to the inner, outer, and/or edge surfaces of each substrate 12.

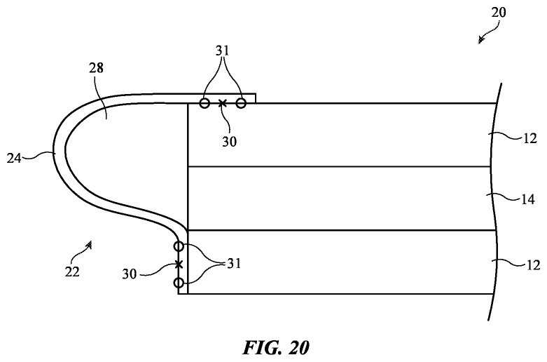

The example of FIG. 5 in which hermetic bonds 30 are used to attach layer 24 to the outer surface of the upper substrate 12 and to the peripheral edge surface 42 of the lower substrate 12 is illustrative. FIG. 20 shows how the hermetic bonds 30 can be mechanically reinforced by non-hermetic bonds 31. Bonds 30 may represent a first type of connection, whereas bonds 31 may represent a second type of connection for attaching layer 24 to substrate 12. Bonds 30 may represent hermetically sealed joints between layer 24 and substrate 12, whereas bonds 31 may represent non-hermetically sealed joints between layer 24 and substrate 12. The hermetic bonds 30 may provide a first amount of mechanical bonding strength, whereas the non-hermetic bonds 31 may provide a second level of mechanical bonding strength greater than the first level of mechanical bonding strength (e.g., non-hermetic bonds 31 provide greater mechanical support and load-bearing capabilities than hermetic bonds 30). The non-hermetic bonds 31 can therefore provide improved structural support for ensuring that the connection between layers 12 and 24 is mechanically sound. The use of load-bearing bonds 31 in addition to the non-load-bearing but hermetic bonds 30 can help relieve mechanical stress that might otherwise be applied to the hermetic bonds 30, which can be beneficial and technically advantageous to prevent cracks, damage to substrate 12, or other mechanical failure in seal 22 of optical component 20. The non-hermetic bonds 31 can be formed on both sides of the hermetic bonds 30 (as shown in FIG. 20), can optionally be formed on only one side of the hermetic bonds 30, and/or can be formed between adjacent hermetic bonds 30.

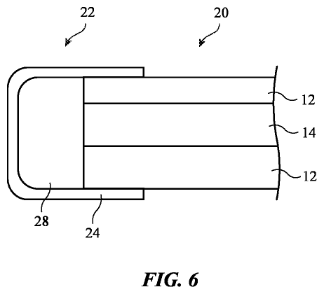

In the example of FIG. 6, buffer 28 has a rectangular shape with a pair of right-angle corners adjacent to substrates 12 and a pair of rounded corners that support corresponding curved portions of layer 24. This type of shape for buffer 28 may help reduce the width of buffer 28.

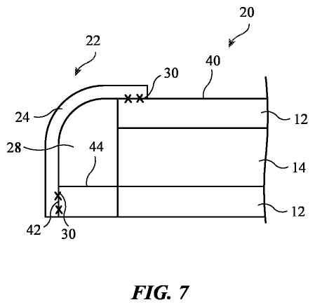

In the illustrative arrangement of FIG. 7, substrates 12 have different sizes (e.g., different lateral dimensions). This causes one of the substrates 12 to protrude laterally relative to the other, thereby forming ledge 44. Buffer 28 may have one surface that covers the peripheral edge of one of the substrates and the peripheral edge of layer 14 and another surface that rests on ledge 44. Layer 42 may be bonded with bonds 30 to outer surface 40 of a first of substrates 12 and to peripheral edge 42 of the second of substrates 12 (e.g., the protruding substrate). This type of arrangement for seal 22, in which layer 24 is bonded with both substrate face bonds and substrate edge bonds, may help ensure that one glass substrate face is clear of seal 22 (e.g., to provide space for attachment of housing 18).

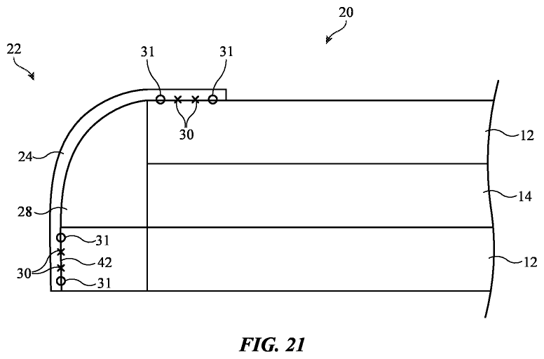

The example of FIG. 7 in which hermetic bonds 30 are used to attach layer 24 to the outer surface of the upper substrate 12 and to the peripheral edge surface 42 of the ledge portion 44 is illustrative. FIG. 21 shows how the hermetic bonds 30 can be mechanically reinforced by non-hermetic bonds 31. The use of load-bearing bonds 31 in addition to the non-load-bearing but hermetic bonds 30 can help relieve mechanical stress that might otherwise be applied to the hermetic bonds 30, which can be beneficial and technically advantageous to prevent cracks, damage to substrate 12, or other mechanical failure in seal 22 of optical component 20. The non-hermetic bonds (joints) 31 can be formed on both sides of the hermetic bonds 30 (as shown in FIG. 21), can optionally be formed on only one side of the hermetic bonds 30, and/or can be formed between adjacent hermetic bonds 30.

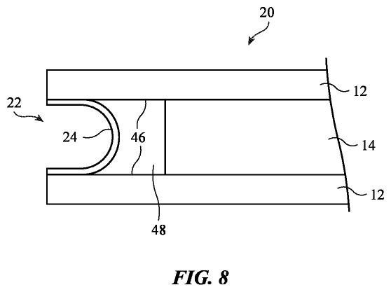

FIG. 8 shows how layer 24 may be bonded to inner surfaces 46 of substrates 12. Gap 48 may be an air-filled gap or may be filled with buffer material to form a buffer such as buffer 28 of FIG. 3. In arrangements of the type shown in FIG. 8, both outer substrate surfaces of substrates 12 are clear of layer 24, providing additional area for attachment of housing 18.

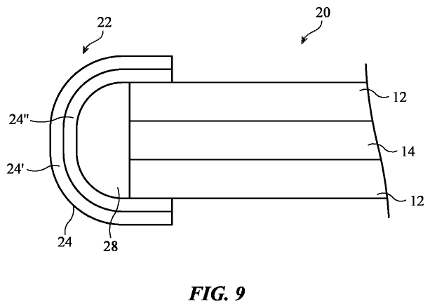

Layer 24 may be formed from one or more materials (organic materials, inorganic materials, elemental metals and/or metal alloys forming metal foil, thin-film metal coatings, or other metal layers, low-water-vapor-transmission polymer, hybrid organic/inorganic materials, and/or other materials). As shown in FIG. 9, for example, layer 24 may be a moisture barrier layer having a substrate layer such as substrate layer 24″ (e.g., a polymer layer) that is covered with a moisture-impermeable layer such as moisture barrier coating 24′. Moisture barrier coating 24′ may be formed from one or more materials that are impervious to moisture. For example, coating 24′ may be a thin-film metal layer such as a thin-film layer of aluminum, nickel, chromium, or other metal or may be a dielectric thin-film layer formed from inorganic materials such as silicon nitride or other nitrides, aluminum oxide or other oxides, etc. Coating 24′ may be formed from a single thin-film coating layer or may be formed from a stack of multiple thin-film coating layers (e.g., layers of different materials).

In general, layer 24 may be formed entirely of metal (e.g., layer 24 may be a metal foil), may include one or more polymer layers (e.g., for providing layer 24 with strength) and/or may include one or more metal thin-film layers and/or dielectric thin-film layers (e.g., for providing layer 24 with a moisture resistant coating). Layer 24 may, if desired, include sufficient opaque material (e.g., opaque polymer, metal, etc.) to make layer 24 opaque so that layer 24 can serve as a light seal in addition to serving as a moisture barrier seal.

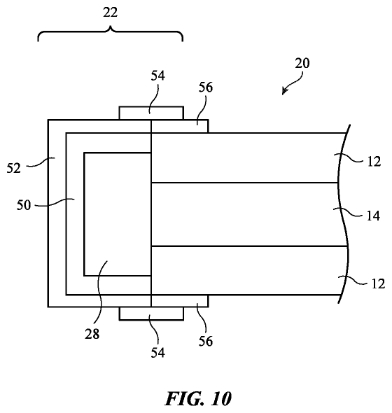

If desired, planar seam sealing arrangements may be used in hermetically sealing the structures of seal 22 to component 20. Consider, as an example, the arrangement of FIG. 10. As shown in FIG. 10, buffer 28 may be formed on the peripheral edge of component 20 (e.g., using polymer thermoforming). An adhesive layer such as polymer layer 50 may then be formed on buffer 28. A moisture barrier such as metal layer 52 (e.g., metal foil) may be attached to the exposed outer surface of the adhesive layer so that layer 50 and layer 52 serve as a moisture barrier layer. Metal may also be formed in thin strips running along the periphery of component 20 (see, e.g., metal layers 56 on the outer surfaces of substrates 12). These strip-shaped metal layers may provide surfaces onto which solder may be attached by soldering. In an illustrative arrangement, each strip is a solder pad formed from sputtered metal layers that provide adhesion, mechanical integrity, and oxidation resistance. The foil layer or other metal layer 52 in seal 22 serves as a moisture barrier layer for seal 22. To hermetically seal layer 52 to component 20, seam-sealing layers 54 (e.g., strips of solder, other metal, or other sealing material running along the peripheral edge of component 20) may be used to bridge the interface between the metal of foil 52 and the metal of strips 56, thereby bonding metal layer 52 to substrates 12 (e.g., sealing the seams formed between metal layer 52 and the metal strips of layers 56). In an illustrative configuration, each seam-sealing layer 54 is formed from a strip of solder deposited by a laser-based low-temperature solder ball jetting process followed by flattening using a hot roller covered in polytetrafluorethylene or other non-stick coating material. Other seam sealing techniques may be used to attach the seal structures of FIG. 10 to the periphery of element 20, if desired.

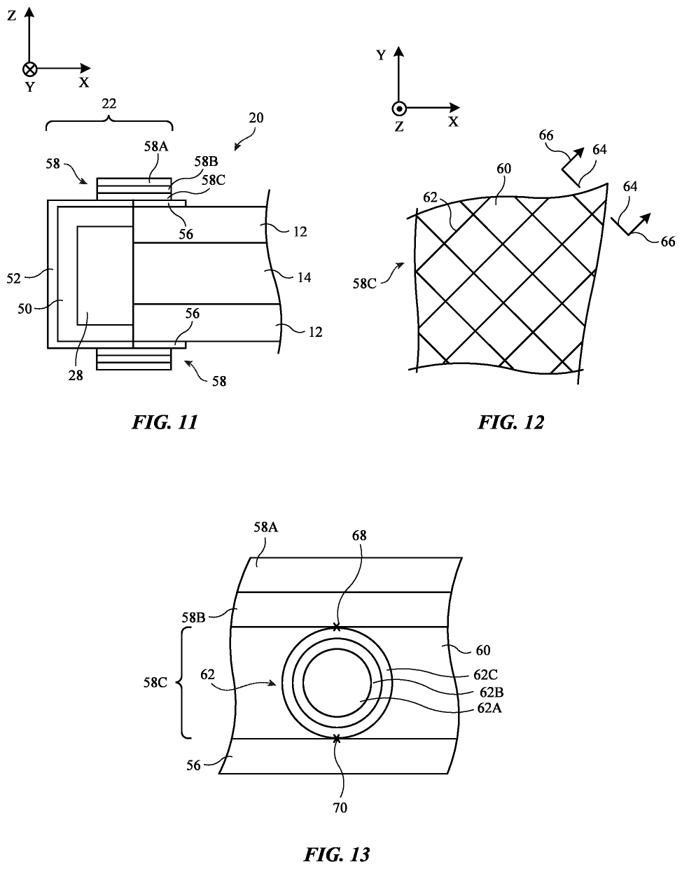

In the example of FIGS. 11, 12, and 13, a mesh tape arrangement is used in forming seal 22. As shown in FIG. 11, mesh tape seals are formed on opposing sides of the peripheral edge of component 20, using mesh-tape-based sealing strips 58. Each of strips 58 runs along the periphery of component 20 and attaches the outer surface of one of substrates 12 to corresponding exposed seal surfaces (e.g., the adjacent exposed surfaces of the moisture barrier layer formed from metal layer 52).

As shown in FIG. 11, each strip 58 may include a carrier substrate such as tape carrier 58A (e.g., a polymer tape substrate layer), may include a moisture barrier layer such as moisture barrier layer 58B (e.g., a metal thin-film layer such as a thin-film layer of copper and nickel or other metal(s)), and adhesive layer 58C. Adhesive layer 58C may have an embedded mesh to prevent lateral moisture ingress. The mesh may form solder bonds with the metal of layers 52 and 56, respectively.

A top view of layer 58C is shown in FIG. 12. As shown in FIG. 12, layer 58C may include adhesive 60 (e.g., polymer adhesive) and mesh 62. Mesh 62 may be formed from a grid of moisture-impermeable strands or other structures forming a two-dimensional array of openings to receive adhesive 60. Each strand may, as an example, be formed from a wire or a polymer core coated with one or more metal layers.

FIG. 13 is a cross-sectional side view of a strand of mesh 62 of FIG. 12 taken along line 64 of FIG. 12 and viewed in direction 66. In this illustrative configuration, mesh 62 has strands of material that are formed from cores 62A (e.g., core material formed from polymer, glass, and/or metal) coated with a first coating layer 62B and a second coating layer 62C. Coating layer 62B may be, for example, a nickel shell or other metal shell deposited by electroless plating. Coating layer 62C may be, for example, a low-temperature solder coating deposited by electroplating. Coating 62C may be melted to form solder joints (e.g., solder bond 68 between mesh 62 and the metal of layer 58B and solder bond 70 between mesh 62 and the metal of layer 56). In this way, strip 58 may be bonded to the metal of layer 56 and the metal of layer 52, thereby hermetically attaching (bonding) seal 22 to the edge of component 20.

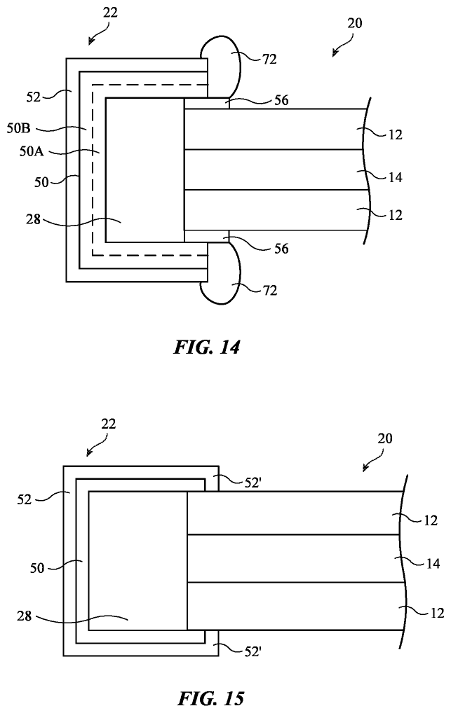

Alternatives to using an adhesive with an embedded mesh coated with a barrier layer are shown in FIGS. 14 and 15.

In the illustrative sealing arrangement of FIG. 14, an elongated strip of solder such as solder bead 72 is used in forming a solder bond and hermetic seal between metal layer 52 and metal layer 56. In this type of arrangement, layer 50 may be a layer of adhesive tape supported by buffer 28. Layer 50 may have a first layer (adhesive layer 50A) covered with a second layer (e.g., a catalyst-loaded layer such as a palladium-loaded layer) to promote electroless plating growth of subsequently formed metal layer 52. After attaching layer 50 to layer 56 using adhesive layer 50A (while leaving portions of layer 56 exposed), layer 52 may be grown on layer by electroless plating. Solder 72 may then be used to form a solder seal along the interface between layers 52 and 56. This forms a hermetic seal for seal 22.

In the illustrative sealing arrangement of FIG. 15, a seal is formed using electroless plating. Layer 50 may be a homogenized composite adhesive tape whose exposed surfaces are suitable to serve as a catalyst for electroless plating. Layer 50 may be formed from polymer with a bulk catalyst dopant such as a palladium catalyst. Seal 22 of FIG. 15 may be formed by attaching the adhesive of layer 50 to the outer surfaces of substrates 12 followed by electroless plating of metal layer 52 onto the exposed surfaces of layer 50. During electroless plating operations, portions 52′ of layer 52 contact the outer surfaces of substrates 12 and the bonds formed between portions 52′ and substrates 12 (and/or, peripheral metal strips on substrates 12) hermetically seal layer 52 to element 20.

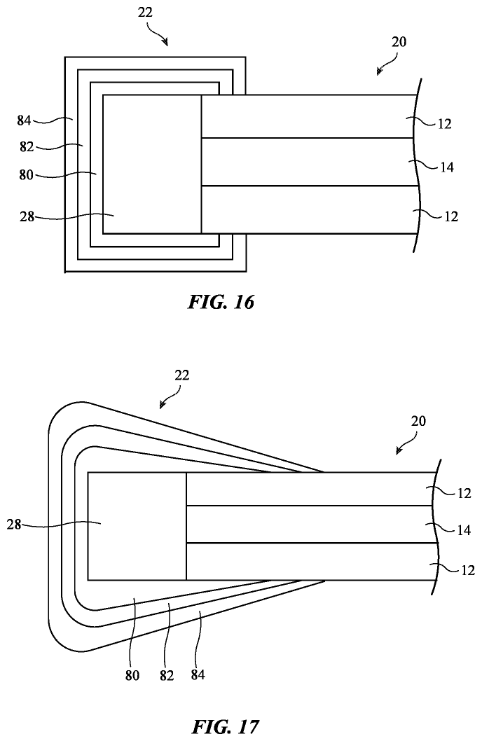

If desired, multilayer coatings may be used in forming seal 22. Consider, as an, the illustrative seals of FIGS. 16 and 17.

As shown in FIG. 16, seal 22 may have a first (innermost) layer 80, a second (middle) layer 82, and a third (outermost) layer 84. These layers may be formed around the entire peripheral edge of component 20 and may cover buffer 28. If desired, seal 22 may have additional layers (e.g., one or more coatings on layer 84). The arrangement of FIG. 16 in which seal 22 has three layers is illustrative.

Innermost layer 80 may be a polymer layer that prepares the edge of component 20 for subsequent hermetic sealing layers. Layer 80 may be deposited using low-injection pressure overmolding (LIPO) deposition techniques, needle dispensing techniques, three-dimensional dispensing techniques, or other suitable deposition techniques. The polymer material forming layer 80 may be epoxy, acrylic, a composite such as a polymer with embedded particles (e.g., epoxy with embedded silica particles or other filler particles, acrylic with embedded silica particles or other filler particles, etc.). The thickness of layer 80 may be 0.05 microns to 1 mm, micron to 500 microns, at least 0.1 micron, at least 1 micron, at least 10 microns, less than 2000 microns, less than 1000 microns, less than 500 microns, less than 200 microns, or other suitable thickness. The coefficient of thermal expansion of layer 80 may be less than 100 ppm or other suitable value. The elastic modulus of layer 80 may be 10-2000 MPa, at least 1 MPa, at least 10 MPa, at least 100 MPa, less than 10,000 MPa, less than 3000 MPa, less than 1000 MPa, less than 300 MPa, less than 50 MPa, or other suitable value. Layer 80 may exhibit a critical strain of at least 5%.

Middle layer 82, which forms a moisture barrier layer, may contain one or more sublayers of material that help enhance the hermetic sealing properties of seal 22. Each sublayer may be a metal oxide layer, a ceramic layer, a polymer layer, or other suitable hermetic sealing layer. In an illustrative single-layer configuration, layer 82 contains a single layer of metal oxide or ceramic deposited by plasma-enhanced atomic layer deposition. In an illustrative dual-layer configuration, a first of two sublayers in layer 82 may be a metal oxide or ceramic layer deposited by plasma-enhanced atomic layer deposition and a second of the two sublayers in layer 82 may be another metal oxide or ceramic layer deposited by plasma-enhanced atomic layer deposition (e.g., a different material than the first sublayer of the dual layer). In an illustrative configuration involving more than two sublayers, a stack of two or more pairs of sublayers may be used to form layer 82. Each pair of sublayers may have a first sublayer formed from metal oxide, ceramic, or polymer and may have a second sublayer formed from metal oxide or ceramic. These materials may be deposited by plasma-enhanced atomic layer deposition (as an example). Examples of metal oxide and ceramic materials (inorganic materials) that may be used for forming layer 82 include aluminum oxide, titanium oxide, zinc oxide, zirconium oxide, silicon oxide, silicon nitride, and aluminum nitride. Examples of multiple-layer inorganic and/or organic hybrid films that may be deposited (e.g., when forming a stack of sublayers pairs) include films based on sublayer pairs such as an aluminum-oxide/titanium-oxide pair, aluminum-oxide/silicon-oxide pair, an aluminum-oxide/alucone pair, an aluminum-oxide/polymer pair, etc. The thickness of layer 82 is generally less than the thickness of layer 80 and less than the thickness of layer 84. As an example, the thickness of layer 82 may be 0.05 nm to 1 micron, 0.1 nm to 500 nm, at least 0.1 nm, at least 1 nm, at least 10 nm, less than 2000 nm, less than 1000 nm, less than 500 nm, less than 200 nm, or other suitable thickness.

Outer layer 84, which may optionally be the outermost layer of seal 22, may be a polymer protection layer that is dispensed using a three-dimensional dispersion deposition technique or other suitable deposition technique. Layer 84 may be formed from a polymer such as silicone, acrylate, or other polymer that may help protect underlying layers in seal 22 such as layers 80 and 82. The thickness of layer 84 may be 0.05 microns to 1 mm, 0.1 micron to 500 microns, at least 0.1 micron, at least 1 micron, at least 10 microns, less than 2000 microns, less than 1000 microns, less than 500 microns, less than 200 microns, or other suitable thickness. The coefficient of thermal expansion of layer 84 may be less than 500 ppm or other suitable value. The elastic modulus of layer 84 may be 0.1-100 MPa, at least 0.01 MPa, at least 0.1 MPa, at least 1 MPa, less than 1000 MPa, less than 300 MPa, less than 100 MPa, less than 30 MPa, less than 5 MPa, or other suitable value. In an illustrative configuration the elastic modulus of layer 84 is less than the elastic modulus of layer 80 (e.g., layer 80 may be rigid polymer, whereas layer 84 may be formed from an elastomeric polymer). Layer 80 may exhibit a critical strain of at least 100%.

As shown in FIGS. 16 and 17, buffer 28 may be interposed between layer 80 and the peripheral edge of layer 14. If desired, buffer 28 may be omitted.

If desired, the layers of seal 22 may have tapered profiles as shown in FIG. 17. Seals such as seal 22 of FIG. 16 and seal 22 of FIG. 17 may exhibit low moisture vapor transmission rates (e.g., a water vapor transmission rate of about 10⁻⁴ g/m²/day or less), may exhibit satisfactory resistance to seal breakage and leakage, may exhibit uniformly conformal layer deposition characteristics that help make seal 22 insensitive to variations in the shape and profile at the edge of component 20, may exhibit a satisfactorily low border size and weight, may exhibit low stress and no air gaps, and may help avoid overly complex fabrication techniques while exhibiting a desirable appearance.

In accordance with an embodiment, an optical component is provided that includes first and second glass layers, a polymer layer between the first and second glass layers, and a seal formed from a barrier layer that hermetically seals a peripheral edge of the polymer layer, the barrier layer includes a layer of metal and the barrier layer is attached to the first glass layer and the second glass layer.

In accordance with another embodiment, the optical component includes the barrier layer is attached to a first surface of the first glass layer and is attached to a second surface of the second glass layer, the seal includes an elastomeric buffer configured to support the barrier layer, and the layer of metal has a first portion with a first edge that is bonded to the first surface and a second edge and has a second portion with a third edge that is bonded to the second surface and a fourth edge that is bonded to the second edge.

In accordance with another embodiment, the layer of metal is attached to a first surface of the first glass layer and is attached to a second surface of the second glass layer.

In accordance with another embodiment, the seal includes adhesive that bonds the layer of metal to the first and second surfaces.

In accordance with another embodiment, the seal includes solder that bonds the layer of metal to the first and second surfaces.

In accordance with another embodiment, the layer of metal is welded to the first and second surfaces using welds.

In accordance with another embodiment, the barrier layer has a polymer substrate covered with the layer of metal.

In accordance with another embodiment, the seal includes adhesive.

In accordance with another embodiment, the adhesive bonds the layer of metal to the first and second glass layers.

In accordance with another embodiment, the barrier layer includes a polymer layer and the layer of metal includes a plated metal layer on the polymer layer.

In accordance with another embodiment, the barrier layer includes a polymer layer coated with the layer of metal, the seal includes a first metal strip on a first surface of the first glass layer, first solder that seals a first edge of the layer of metal to the first metal strip, a second metal strip on a second surface of the second glass layer, and second solder that seals a second edge of the layer of metal to the second metal strip.

In accordance with another embodiment, the first and second glass layers each have an outer surface and an opposing inner surface and the inner surfaces of the first and second glass layers face each other.

In accordance with another embodiment, the barrier layer is bonded to the outer surfaces of the first and second glass layers.

In accordance with another embodiment, barrier layer has a first edge bonded to the outer surface of the first glass layer and has a second edge bonded to a peripheral edge surface of the second glass layer and the peripheral edge surface that extends between the inner surface of the second glass layer and the outer surface of the second glass layer.

In accordance with another embodiment, the barrier layer has opposing first and second surfaces, a first area of the first surface is bonded to the inner surface of the first glass layer, and has a second area of the first surface is bonded to the inner surface of the second glass layer.

In accordance with another embodiment, the layer of metal is attached to the first and second glass layers using first and second sealing strips, the sealing strips each include a substrate layer, a mesh embedded in a layer of adhesive, and a metal layer between the substrate layer and the layer of adhesive.

In accordance with another embodiment, the optical component includes metal strips on the first and second glass layers, the metal mesh of the first and second sealing strips includes a solder coating that forms solder bonds with the metal strips.

In accordance with an embodiment, an optical component is provided that includes first and second glass layers, a first polymer layer between the first and second glass layers, and a seal formed along a peripheral edge of the first polymer layer, the seal includes a barrier layer having a second polymer layer coated with a barrier coating, the barrier layer has a first edge attached to the first glass layer and a second edge attached to the second glass layer.

In accordance with another embodiment, the barrier coating includes a moisture barrier coating selected from the group consisting of a metal thin-film layer and an inorganic dielectric thin-film layer.

In accordance with an embodiment, an electronic device is provided that includes a support structure, an optical component supported by the support structure, the optical component has first and second glass layers, and has a polymer layer between the first and second glass layers, and a hermetic seal formed along a peripheral edge of the optical component, the hermetic seal includes a first metal layer portion that is attached to the first glass layer and a second metal layer portion that is attached to the second glass layer and a bond is formed between the first and second metal layer portions.

In accordance with an embodiment, an optical component having a periphery and center is provided that includes first and second glass layers, a polymer layer between the first and second glass layers, and a hermetic seal formed along a peripheral edge of the polymer layer, the seal includes a barrier layer having a polymer film coated with a barrier coating, the barrier layer has a first edge attached to the first glass layer and a second edge attached to the second glass layer, there is an edge thickness associated with a distance through the first and second glass layers and the polymer layer at the periphery, there is a center thickness associated with a distance through the first and second glass layers and polymer layer in the center, and the hermetic seal is configured so that over a temperature range of 0° C. to 45° C., the edge thickness exhibits a first thickness change, the center thickness exhibits a second thickness change, and there is a difference between the first and second thickness changes of less than 0.05%.

In accordance with an embodiment, an optical component is provided that includes first and second transparent layers, a polymer layer between the first and second transparent layers, and a seal that hermetically seals a peripheral edge of the polymer layer, the seal includes a first layer, a second layer, and a third layer, the second layer is between the first and third layers, the first layer includes polymer, the second layer includes a barrier layer and includes at least one inorganic material, and the third layer includes polymer.

In accordance with another embodiment, the first layer includes a polymer layer selected from the group consisting of an epoxy layer, an epoxy layer with embedded particles, an acrylic layer, and an acrylic layer with embedded particles.

In accordance with another embodiment, the first layer has a coefficient of thermal expansion of less than 100 ppm.

In accordance with another embodiment, the first layer has an elastic modulus of 10-2000 MPa.

In accordance with another embodiment, the first layer includes a polymer layer selected from the group consisting of silicone and acrylate.

In accordance with another embodiment, the first layer has a first elastic modulus and the third layer has a second elastic modulus that is less than the first elastic modulus.

In accordance with another embodiment, the third layer has a coefficient of thermal expansion of less than 500 ppm.

In accordance with another embodiment, the third layer has an elastic modulus of 0.1-100 MPa.

In accordance with another embodiment, the second layer is a layer of metal oxide or ceramic.

In accordance with another embodiment, the second layer includes first and second sublayers and the first and second sublayers each include a material selected from the group consisting of metal oxide and ceramic.

In accordance with another embodiment, the second layer includes a stack of multiple sublayer pairs, each sublayer pair having a first sublayer and a second sublayer.

In accordance with another embodiment, each of the first sublayers includes metal oxide or ceramic.

In accordance with another embodiment, each of the second sublayers includes a material selected from the group consisting of: metal oxide, ceramic, and polymer.

In accordance with another embodiment, the second layer is thinner than the first and third layers.

In accordance with another embodiment, the first, second, and third layers have tapered profiles.

In accordance with another embodiment, the optical component includes a buffer between the peripheral edge of the polymer layer and the first layer.

The foregoing is merely illustrative and various modifications can be made to the described embodiments. The foregoing embodiments may be implemented individually or in any combination.

What is claimed is:

1. An optical component, comprising:
first and second glass layers;
a polymer layer between the first and second glass layers; and
a seal formed from a barrier layer that hermetically seals a peripheral edge of the polymer layer, wherein the barrier layer comprises a layer of metal and wherein the barrier layer is attached to the first glass layer and the second glass layer.

2. The optical component defined in claim 1 wherein the barrier layer is attached to a first surface of the first glass layer and is attached to a second surface of the second glass layer, wherein the seal comprises an elastomeric buffer configured to support the barrier layer, and wherein the layer of metal has a first portion with a first edge that is bonded to the first surface and a second edge and has a second portion with a third edge that is bonded to the second surface and a fourth edge that is bonded to the second edge.

3. The optical component defined in claim 1 wherein the layer of metal is attached to a first surface of the first glass layer and is attached to a second surface of the second glass layer.

4. The optical component defined in claim 3 wherein the seal comprises adhesive that bonds the layer of metal to the first and second surfaces.

5. The optical component defined in claim 3 wherein the seal comprises solder that bonds the layer of metal to the first and second surfaces.

6. The optical component defined in claim 3 wherein the layer of metal is welded to the first and second surfaces using welds.

7. The optical component defined in claim 1 wherein the barrier layer has a polymer substrate covered with the layer of metal.

8. The optical component defined in claim 7 wherein the seal comprises adhesive.

9. The optical component defined in claim 8 wherein the adhesive bonds the layer of metal to the first and second glass layers.

10. The optical component defined in claim 1 wherein the barrier layer comprises a polymer layer and wherein the layer of metal comprises a plated metal layer on the polymer layer.

11. The optical component defined in claim 1 wherein the barrier layer comprises a polymer layer coated with the layer of metal, wherein the seal comprises:
a first metal strip on a first surface of the first glass layer;
first solder that seals a first edge of the layer of metal to the first metal strip;
a second metal strip on a second surface of the second glass layer; and
second solder that seals a second edge of the layer of metal to the second metal strip.

12. The optical component defined in claim 1 wherein the first and second glass layers each have an outer surface and an opposing inner surface and wherein the inner surfaces of the first and second glass layers face each other.

13. The optical component defined in claim 12 wherein the barrier layer is bonded to the outer surfaces of the first and second glass layers.

14. The optical component defined in claim 12 wherein barrier layer has a first edge bonded to the outer surface of the first glass layer and has a second edge bonded to a peripheral edge surface of the second glass layer and wherein the peripheral edge surface that extends between the inner surface of the second glass layer and the outer surface of the second glass layer.

15. The optical component defined in claim 12 wherein the barrier layer has opposing first and second surfaces, wherein a first area of the first surface is bonded to the inner surface of the first glass layer, and wherein has a second area of the first surface is bonded to the inner surface of the second glass layer.

16. The optical component defined in claim 1 wherein the layer of metal is attached to the first and second glass layers using first and second sealing strips, wherein the sealing strips each include a substrate layer, a mesh embedded in a layer of adhesive, and a metal layer between the substrate layer and the layer of adhesive.

17. The optical component defined in claim 16 further comprising metal strips on the first and second glass layers, wherein the metal mesh of the first and second sealing strips comprises a solder coating that forms solder bonds with the metal strips.

18. The optical component of claim 1 wherein the barrier layer is attached to a surface of the first glass layer via a first type of bond and via a second type of bond different than the first type of bond.

19. The optical component of claim 18 wherein the first type of bond comprises a hermetic bond and wherein the second type of bond comprises a non-hermetic bond.

20. The optical component of claim 19 wherein the hermetic bond provides a first amount of structural support and wherein the non-hermetic bond provides a second amount of structural support greater than the first amount of structural support.

21. The optical component of claim 19 wherein the hermetic bond forms a first continuous joint for the seal and wherein the non-hermetic bond comprises first and second continuous joints disposed along inner and outer peripheral edges of the hermetic bond.

22. The optical component of claim 19 wherein the hermetic bond forms a first continuous joint for the seal and wherein the non-hermetic bond comprises first and second arrays of discrete joints disposed along inner and outer peripheral edges of the hermetic bond.

23. An optical component, comprising:
first and second glass layers;
a first polymer layer between the first and second glass layers; and
a seal formed along a peripheral edge of the first polymer layer, wherein the seal includes a barrier layer having a second polymer layer coated with a barrier coating, wherein the barrier layer has a first edge attached to the first glass layer and a second edge attached to the second glass layer.

24. The optical coating defined in claim 23 wherein the barrier coating comprises a moisture barrier coating selected from the group consisting of: a metal thin-film layer and an inorganic dielectric thin-film layer.

25. An electronic device, comprising:
a support structure;
an optical component supported by the support structure, wherein the optical component has first and second glass layers, and has a polymer layer between the first and second glass layers; and
a hermetic seal formed along a peripheral edge of the optical component, wherein the hermetic seal comprises a first metal layer portion that is attached to the first glass layer and a second metal layer portion that is attached to the second glass layer and wherein a bond is formed between the first and second metal layer portions.

26. The electronic device of claim 25, further comprising:
a non-hermetic seal formed along the peripheral edge of the optical component, wherein the non-hermetic seal is configured to provide additional mechanical support for the hermetic seal.

27. The electronic device of claim 26, wherein the non-hermetic seal comprises continuous or discrete welds.

28. An optical component having a periphery and center, comprising:
first and second glass layers;
a polymer layer between the first and second glass layers; and
a hermetic seal formed along a peripheral edge of the polymer layer,
wherein the seal includes a barrier layer having a polymer film coated with a barrier coating, wherein the barrier layer has a first edge attached to the first glass layer and a second edge attached to the second glass layer, wherein there is an edge thickness associated with a distance through the first and second glass layers and the polymer layer at the periphery, wherein there is a center thickness associated with a distance through the first and second glass layers and polymer layer in the center, and wherein the hermetic seal is configured so that over a temperature range of 0° C. to 45° C., the edge thickness exhibits a first thickness change, the center thickness exhibits a second thickness change, and there is a difference between the first and second thickness changes of less than 0.05%.

29. An optical component, comprising:
first and second transparent layers;
a polymer layer between the first and second transparent layers; and
a seal that hermetically seals a peripheral edge of the polymer layer, wherein the seal comprises a first layer, a second layer, and a third layer, wherein the second layer is between the first and third layers, wherein the first layer comprises polymer, wherein the second layer comprises a barrier layer and includes at least one inorganic material, and wherein the third layer comprises polymer.

30. The optical component defined in claim 29 wherein the first layer comprises a polymer layer selected from the group consisting of: an epoxy layer, an epoxy layer with embedded particles, an acrylic layer, and an acrylic layer with embedded particles.

31. The optical component defined in claim 29 wherein the first layer has a coefficient of thermal expansion of less than 100 ppm.

32. The optical component defined in claim 29 wherein the first layer has an elastic modulus of 10-2000 MPa.

33. The optical component defined in claim 29 wherein the first layer comprises a polymer layer selected from the group consisting of: silicone and acrylate.

34. The optical component defined in claim 29 wherein the first layer has a first elastic modulus and wherein the third layer has a second elastic modulus that is less than the first elastic modulus.

35. The optical component defined in claim 29 wherein the third layer has a coefficient of thermal expansion of less than 500 ppm.

36. The optical component defined in claim 29 wherein the third layer has an elastic modulus of 0.1-100 MPa.

37. The optical component defined in claim 29 wherein the second layer is a layer of metal oxide or ceramic.

38. The optical component defined in claim 29 wherein the second layer comprises first and second sublayers and wherein the first and second sublayers each comprise a material selected from the group consisting of: metal oxide and ceramic.

39. The optical component defined in claim 29 wherein the second layer comprises a stack of multiple sublayer pairs, each sublayer pair having a first sublayer and a second sublayer.

40. The optical component defined in claim 39 wherein each of the first sublayers comprises metal oxide or ceramic.

41. The optical component defined in claim 40 wherein each of the second sublayers comprises a material selected from the group consisting of: metal oxide, ceramic, and polymer.

42. The optical component defined in claim 29 wherein the second layer is thinner than the first and third layers.

43. The optical component defined in claim 29 wherein the first, second, and third layers have tapered profiles.

44. The optical component defined in claim 29 further comprising a buffer between the peripheral edge of the polymer layer and the first layer.
